(19) United States
(12) Patent Application Publication
(10) Pub. No.: US 2023/0070029 A1
(43) Pub. Date: Mar. 9, 2023

(54) DETECTION SYSTEM, DETECTION DEVICE, AND DETECTION METHOD

(71) Applicant: NEC Corporation, Minato-ku, Tokyo (JP)

(72) Inventors: Tadayuki IWANO, Tokyo (JP); Yoshiaki AONO, Tokyo (JP); Yoshinori KITAHARA, Tokyo (JP); Yuusuke SAKURAI, Tokyo (JP)

(73) Assignee: NEC Corporation, Minato-ku, Tokyo (JP)

(21) Appl. No.: 17/798,387

(22) PCT Filed: Feb. 28, 2020
(86) PCT No.: PCT/JP2020/008456

§ 371 Date: Aug. 9, 2022

(51) Int. Cl. G01H 9/00; G08B 13/189

(52) U.S. Cl. CPC G01H 9/004; G08B 13/189

(57) ABSTRACT

A detection system according to the present disclosure includes an optical fiber (10X, 10Y) laid in a portable base station area (45) in which a portable base station (40) is installed, a reception unit (20) receiving an optical signal from the optical fiber (10X, 10Y), the optical signal containing information indicating a state of the portable base station area (45), and a detection unit (32) detecting a threat in the portable base station area (45), based on the information indicating a state of the portable base station area (45) being contained in the optical signal.

### TECHNICAL FIELD

The present disclosure relates to a detection system, a detection device, and a detection method.

### BACKGROUND ART

In recent years, destruction, theft, and the like of equipment in a portable base station area in which a portable base station is installed have become problems. In the portable base station area, monitoring is mainly performed by watchman patrolling, but it is difficult to detect the destruction, the theft, and the like of the equipment described above only by monitoring by the watchman patrolling.

Meanwhile, the portable base station uses an optical fiber as a communication line. Recently, a technique called optical fiber sensing using an optical fiber as a sensor has attracted attention, and various proposals using optical fiber sensing have been made.

For example, Patent Literature 1 discloses a technique of measuring state intensity (vibration intensity, sound, temperature, etc.) of each of a plurality of monitoring targets, based on observation of scattered light with respect to incident light being incident on an optical fiber, and identifying a monitoring target the state intensity of which is equal to or greater than a threshold value.

### CITATION LIST

### Patent Literature

[Patent Literature 1] Japanese Unexamined Patent Application Publication No. 2019-113513

### SUMMARY OF INVENTION

### Technical Problem

However, in the technique disclosed in Patent Literature 1, only a monitoring target the state intensity of which is equal to or greater than a threshold value is specified from among a plurality of monitoring targets, and it is not determined what event has occurred in the monitoring target the state intensity of which is equal to or greater than the threshold value.

Therefore, the technique disclosed in Patent Literature 1 has a problem that it is difficult to comprehensively detect a threat such as destruction and theft of equipment in the portable base station area.

Therefore, an object of the present disclosure is to provide a detection system, a detection device, and a detection method that are capable of solving the problem described above and comprehensively detecting a threat in a portable base station area.

### Solution to Problem

A detection system according to one aspect includes:

an optical fiber configured to be laid in a portable base station area in which a portable base station is installed;

a reception unit configured to receive an optical signal from the optical fiber, the optical signal including information indicating a state of the portable base station area; and

a detection unit configured to detect a threat in the portable base station area, based on the information indicating a state of the portable base station area being included in the optical signal.

A detection device according to one aspect includes:

an acquisition unit configured to acquire information indicating a state of a portable base station area in which a portable base station is installed, the information being included in an optical signal received from an optical fiber laid in the portable base station area; and

a detection unit configured to detect a threat in the portable base station area, based on the information indicating a state of the portable base station area.

A detection method according to one aspect is a detection method by a detection system, the detection method including:

a receiving step of receiving an optical signal from an optical fiber laid in a portable base station area in which a portable base station is installed, the optical signal including information indicating a state of the portable base station area; and

a detecting step of detecting a threat in the portable base station area, based on the information indicating a state of the portable base station area being included in the optical signal.

### Advantageous Effects of Invention

According to the above-described aspects, it is possible to provide a detection system, a detection device, and a detection method that are capable of comprehensively detecting a threat in a portable base station area.

### BRIEF DESCRIPTION OF DRAWINGS

FIG. 1 is a diagram illustrating a configuration example of a detection system according to a first example embodiment;

FIG. 2 is a diagram illustrating a configuration example of the detection system according to the first example embodiment;

FIG. 3 is a diagram illustrating an example of a correspondence table held by a detection unit according to the first example embodiment;

FIG. 4 is a flow chart illustrating an example of an operation flow of the detection system according to the first example embodiment;

FIG. 5 is a diagram illustrating a configuration example of a detection system according to a second example embodiment;

FIG. 6 is a diagram illustrating an example of a GUI screen displayed on a display unit by a report unit according to the second example embodiment;

FIG. 7 is a flow chart illustrating an example of an operation flow of the detection system according to the second example embodiment;

FIG. 8 is a diagram illustrating a configuration example of a detection system according to a modification example of the second example embodiment;

FIG. 9 is a diagram illustrating an example of a GUI screen displayed on a display unit by a report unit according to the modification example of the second example embodiment;

FIG. 10 is a block diagram illustrating a configuration example of a detection device according to another example embodiment; and

FIG. 11 is a block diagram illustrating an example of a hardware configuration of a computer that implements the detection device according to the example embodiments.

### EXAMPLE EMBODIMENT

Hereinafter, example embodiments of the present disclosure will be described with reference to the drawings. Note that the following description and the drawings are omitted and simplified as appropriate for clarity of description. In the following drawings, the same elements are denoted by the same reference signs, and a repetitive description thereof is omitted as necessary.

### First Example Embodiment

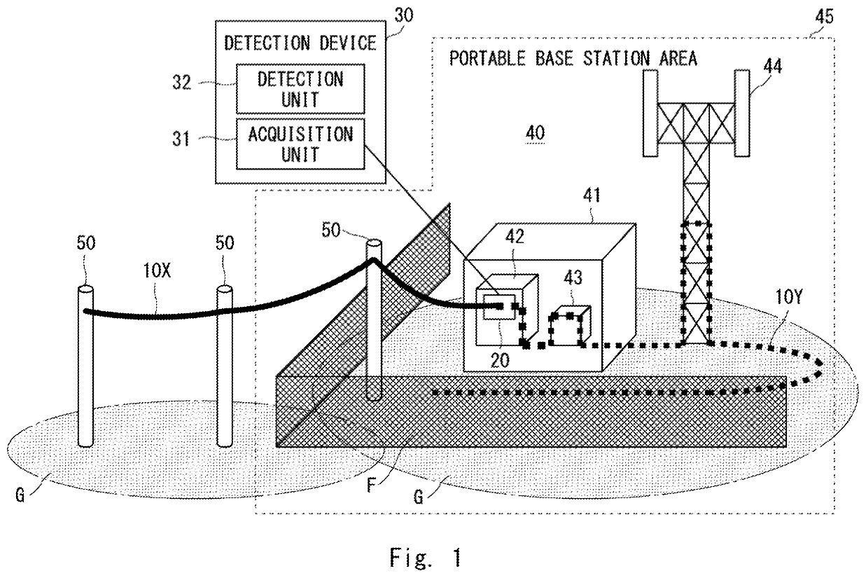

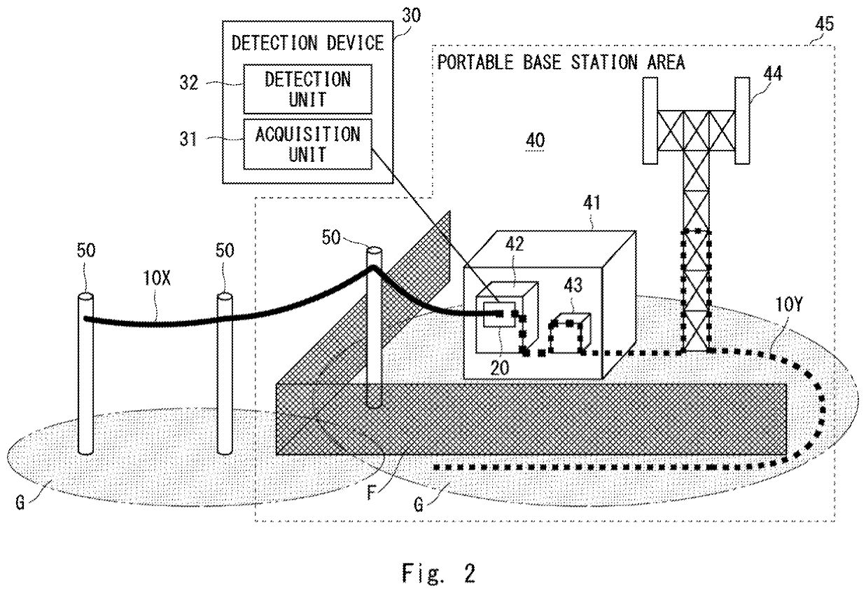

First, with reference to FIGS. 1 and 2, a configuration example of the detection system according to the first example embodiment will be described. Note that, in FIGS. 1 and 2, as will be described later, laying modes of a part of an optical fiber 10Y are different, but other configurations are the same.

First, a portable base station 40 will be described.

As illustrated in FIGS. 1 and 2, the portable base station 40 mainly includes a station 41, an antenna tower 44, and the like. The station 41 is provided with, for example, a wireless device 42, power supply equipment 43, and the like. Although the entire periphery of the portable base station 40 is surrounded by a fence F, in FIGS. 1 and 2, illustration of the fence F on the back side and the right side is omitted for simplification of the drawings.

In recent years, destruction and theft of equipment in a portable base station area 45 in which the portable base station 40 is installed has become a problem.

For example, the destruction of the equipment is an act of destroying the wireless device 42, the power supply equipment 43, the antenna tower 44, the fence F, and the like. The theft of the equipment is an act of stealing the wireless device 42 itself, the power supply equipment 43 itself, and the like, or an act of stealing components of the wireless device 42, the power supply equipment 43, the antenna tower 44, and the like. For example, components of the antenna tower 44 may be bolts or the like of the antenna tower 44.

However, it is difficult to detect the above-described destruction and theft only by monitoring the inside of the portable base station area 45 by a watchman patrolling.

The detection system according to the first example embodiment detects threats such as the above-described destruction and theft in the portable base station area 45, and includes optical fibers 10X, 10Y, a transmission/reception unit 20, and a detection device 30. Hereinafter, in a case where it is not specified whether the optical fiber is the optical fiber 10X or 10Y, the optical fiber is referred to as an optical fiber 10 as appropriate. The detection device 30 includes an acquisition unit 31 and a detection unit 32. Note that, the detection device 30 may be disposed at a position away from the transmission/reception unit 20, and may be disposed on a cloud, for example.

The optical fiber 10X is laid on a plurality of utility poles 50 (three utility poles 50 in the examples of FIGS. 1 and 2), and has one end connected to the transmission/reception unit 20 and the other end connected to an exchange station. Note that the optical fiber 10X may be laid underground G.

On the other hand, the optical fiber 10Y is laid so as to route the wireless device 42, the power supply equipment 43, and the antenna tower 44, and one end thereof is connected to the transmission/reception unit 20. Further, a part of the optical fiber 10Y is laid in the fence F in the example of FIG. 1, and is buried underground G along the fence F in the example of FIG. 2.

Note that the method of laying the optical fibers 10X, 10Y is not limited to the example illustrated in FIG. 1. As long as at least one of the optical fibers 10X and 10Y is laid in the portable base station area 45, the optical fibers 10X, 10Y may be laid in any manner.

The optical fiber 10 may be an optical fiber dedicated for sensing, or may be an optical fiber for both communication and sensing. In a case where the optical fiber 10 is an optical fiber for both communication and sensing, an optical signal for sensing is demultiplexed by a filter (not illustrated) at a front stage of the transmission/reception unit 20, and only the optical signal for sensing may be received by the transmission/reception unit 20.

The transmission/reception unit 20 is provided inside the wireless device 42, and receives an optical signal (an optical signal for sensing, hereinafter, the same) from the optical fiber 10X. The transmission/reception unit 20 is one example of a reception unit. For example, the transmission/reception unit 20 inputs pulsed light into the optical fiber 10X, and receives, as an optical signal, backscattered light generated by the pulsed light being transmitted through the optical fiber 10X. The transmission/reception unit 20 also receives an optical signal from the optical fiber 10Y in the same manner as the optical fiber 10X.

Note that the installation destination of the transmission/reception unit 20 is not limited to the inside of the wireless device 42. For example, the transmission/reception unit 20 may be arranged on the line concentrating station side of the optical fiber 10X or the optical fiber 10Y. When the transmission/reception unit 20 is arranged on the exchange station side, even if a power failure or the like of the power supply equipment 43 occurs, it is possible to detect an event that has occurred in the portable base station area 45 as long as the optical fiber 10 is not disconnected.

Herein, in the portable base station area 45, when the above-described destruction, theft, or the like occurs, vibration and sound are generated, and the vibration and sound are transmitted to the optical fiber 10. As a result, the optical signal transmitted through the optical fiber 10 changes in characteristics (e.g., wavelength). Therefore, the optical fiber 10 is able to detect a state such as whether a destruction, a theft, or the like has occurred in the portable base station area 45. Further, the optical signal received by the transmission/reception unit 20 includes information indicating the state of the portable base station area 45 detected by the optical fiber 10.

The acquisition unit 31 acquires information indicating the state of the portable base station area 45 included in the optical signal received by the transmission/reception unit 20.

The detection unit 32 detects threats such as the above-described destruction and theft in the portable base station area 45, based on the information indicating the state of the portable base station area 45 acquired by the acquisition unit 31.

Hereinafter, a method of detecting a threat in the portable base station area 45 by the detection unit 32 will be described in detail.

In the first example embodiment, as a threat in the portable base station area 45, the following destructions and thefts in the portable base station area 45 are assumed.

(1) An act of destroying equipment (the wireless device 42, the power supply equipment 43, the antenna tower 44, the fence F, etc.)
(2) An act of stealing equipment itself (the wireless device 42 itself, the power supply equipment 43 itself, etc.)
(3) An act of stealing components of equipment (the wireless device 42, the power supply equipment 43, the antenna tower 44, etc.)

In the portable base station area 45, when any one of the above-described acts (1) to (3) occurs, the information indicating the state of the portable base station area 45 detected by the optical fiber 10 includes a vibration pattern of a vibration and an acoustic pattern of a sound generated in association with the occurring act. The vibration pattern and the acoustic pattern are variation patterns that dynamically vary, and become inherent variation patterns according to the type of act that has occurred. For example, the vibration pattern is a variation pattern in which the intensity of vibration, the vibration position, the variation transition of the frequency, and the like are different according to the type of the act that has occurred.

That is, in the portable base station area 45, when any one of the above-described acts (1) to (3) occurs, the information indicating the state of the portable base station area 45 detected by the optical fiber 10 includes an inherent vibration pattern and an acoustic pattern that dynamically vary according to the act that occurs among the above-described acts (1) to (3). Using this fact, the detection unit 32 detects the above-described acts (1) to (3) by the following methods. Note that, hereinafter, an example of detecting the above-described acts (1) to (3) using a vibration pattern will be described as one example.

### (A) Method A

For each of the above-described acts (1) to (3), the detection unit 32 stores in advance a vibration pattern of vibration actually generated when the act occurs in the portable base station area 45, as a matching pattern, in a memory (not illustrated) or the like. For example, when the above-described act (1) occurs, it is considered that a vibration pattern or the like of vibration generated when there is a large impact appears. When the above-described act (2) occurs, it is considered that a vibration pattern or the like of vibration generated when a piece of equipment is dragged appears. When the above-described act (3) occurs, it is considered that a vibration pattern or the like of vibration generated when a piece of equipment is disassembled appears.

First, the acquisition unit 31 acquires information indicating the state of the portable base station area 45 included in the optical signal received by the transmission/reception unit 20.

Then, the detection unit 32 compares the vibration pattern included in the information acquired by the acquisition unit 31 with the matching pattern. When a matching pattern, which has a matching degree with the vibration pattern equal to or greater than the threshold value, is present among the matching pattern, the detection unit 32 determines that an act corresponding to the matching pattern has occurred in the portable base station area 45.

At this time, the detection unit 32 is capable of specifying the position at which the optical signal including the information indicating the state of the portable base station area 45 is generated (i.e., the distance of the optical fiber 10 from the transmission/reception unit 20), in the following manner.

For example, the detection unit 32 is able to specify the position at which the optical signal is generated (the distance of the optical fiber 10Y from the transmission/reception unit 20), based on the time difference between the time at which the transmission/reception unit 20 inputs the pulsed light to the optical fiber 10Y and the time at which the optical signal is received from the optical fiber 10Y. Alternatively, the detection unit 32 is able to specify the position at which the optical signal is generated, based on the reception intensity of the optical signal received by the transmission/reception unit 20. For example, as the reception intensity of the optical signal is smaller, the detection unit 32 identifies the position at which the optical signal is generated as a position farther from the transmission/reception unit 20.

Note that the specification of the generation position of the optical signal is not limited to be executed by the detection unit 32. For example, the transmission/reception unit 20 may specify the generation position of the optical signal, and the acquisition unit 31 may acquire information on the generation position of the optical signal from the transmission/reception unit 20.

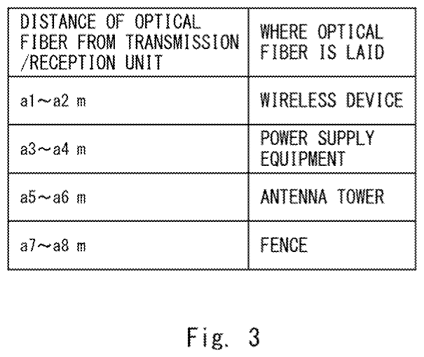

In addition, the detection unit 32 holds a correspondence table in which, for each of the optical fibers 10X and 10Y, the distance of the optical fiber 10 from the transmission/reception unit 20 and the installation destination where the optical fiber 10 at the distance is installed are associated with each other. FIG. 3 illustrates an example of a correspondence table for the optical fiber 10Y.

For example, it is assumed that the detection unit 32 detects the above-described act (1), based on the information indicating the state of the portable base station area 45, the information being included in the optical signal received by the transmission/reception unit 20 from the optical fiber 10Y, and the position at which the optical signal is generated (the distance of the optical fiber 10Y from the transmission/reception unit 20) is within the range of a5 to a6 [m]. In this case, by referring to the correspondence table illustrated in FIG. 3, the detection unit 32 is able to determine that the above-described act (1) with respect to the antenna tower 44, that is, the act of destroying the antenna tower 44, has occurred.

### (B) Method B

The detection unit 32 prepares, for each of the above-described acts (1) to (3), a set including teacher data indicating the act and a vibration pattern of vibration actually generated when the act occurs in the portable base station area 45, inputs each set prepared, constructs a learning model by a convolutional neural network (CNN) in advance, and stores the learning model in advance in a memory (not illustrated) or the like.

First, the acquisition unit 31 acquires information indicating the state of the portable base station area 45 included in the optical signal received by the transmission/reception unit 20.

Then, the detection unit 32 inputs the vibration pattern included in the information acquired by the acquisition unit 31 to the learning model. As a result, when any one of the above-described acts (1) to (3) occurs in the portable base station area 45, the detection unit 32 acquires the act occurring in the portable base station area 45 as the output result of the learning model.

Further, the detection unit 32 may hold a correspondence table as illustrated in FIG. 3, similarly to the method A described above. As a result, the detection unit 32 is able to determine at which equipment in the portable base station area 45 any one of the above-described acts (1) to (3) has occurred, similarly to the method A described above.

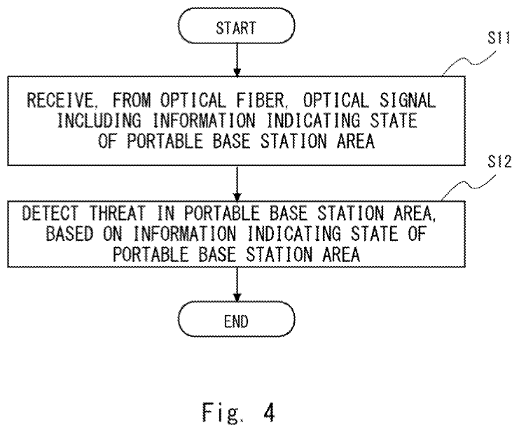

Next, with reference to FIG. 4, an example of an operation flow of the detection system according to the first example embodiment will be described.

As illustrated in FIG. 4, the transmission/reception unit 20 receives an optical signal including information indicating the state of the portable base station area 45 from the optical fiber 10 (step S11).

Then, the acquisition unit 31 acquires information indicating the state of the portable base station area 45 included in the optical signal received by the transmission/reception unit 20, and the detection unit 32 detects a threat (for example, the above-described acts (1) to (3)) in the portable base station area 45, based on the information indicating the state of the portable base station area 45 (step S12). At this time, for example, the detection unit 32 may detect the threat in the portable base station area 45 by using any of the methods A and B described above.

As described above, according to the first example embodiment, the transmission/reception unit 20 receives an optical signal including information indicating the state of the portable base station area 45 from the optical fiber 10. The detection unit 32 detects a threat in the portable base station area 45, based on information indicating the state of the portable base station area 45 included in the optical signal. As a result, since the threat can be detected within a range in which the optical fiber 10 is laid in the portable base station area 45, the threat in the portable base station area 45 can be detected comprehensively.

### Second Example Embodiment

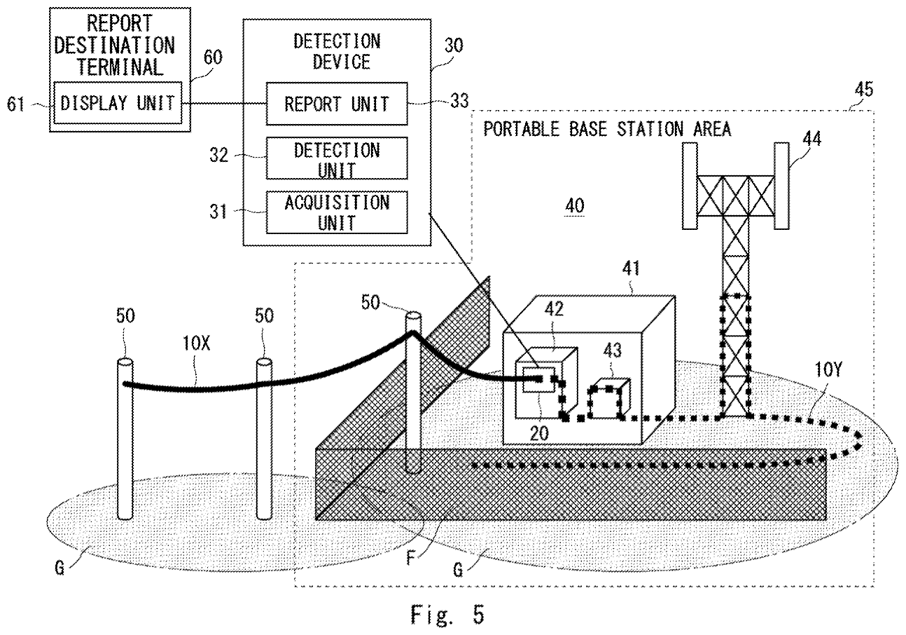

Next, with reference to FIG. 5, a configuration example of a detection system according to the second example embodiment will be described. Note that, the example of FIG. 5 is a modified example of FIG. 1, but the present invention is not limited to this, and may be a modified example of FIG. 2.

As illustrated in FIG. 5, the detection system according to the second example embodiment differs from the configuration of the first example embodiment described above in that a report destination terminal 60 is added and that a report unit 33 is added inside the detection device 30.

The report destination terminal 60 is a terminal installed at a destination to which a report is made when a threat occurs in the portable base station area 45. The report destination is, for example, a fire department, a police department, or the like. Further, the report destination terminal 60 includes a display unit 61, which is a display, a monitor, or the like, for displaying various types of information.

When the detection unit 32 determines that a threat has occurred in the portable base station area 45, the report unit 33 reports to the report destination terminal 60 of the occurrence of the threat in the portable base station area 45 by telephone, mail, or the like.

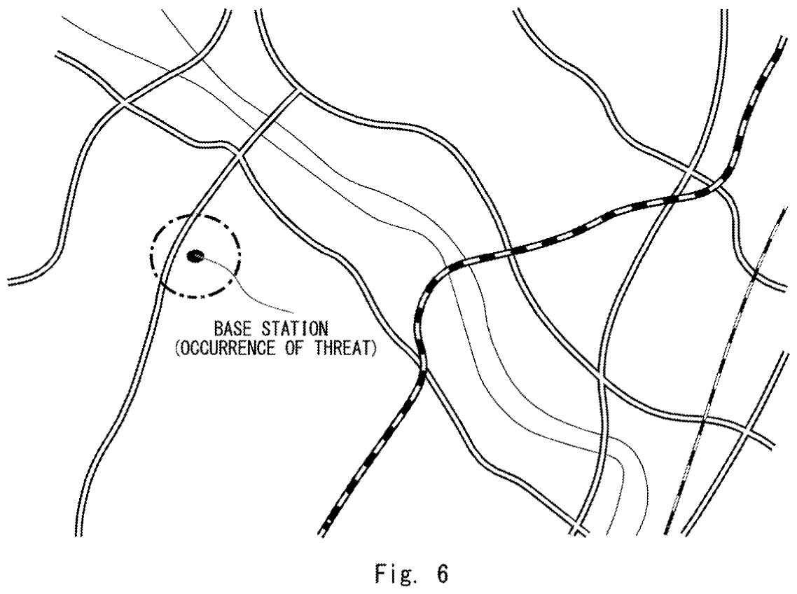

Further, the report unit 33 may hold in advance information indicating the position of the portable base station area 45 and map information in association with each other. When the detection unit 32 determines that a threat has occurred in the portable base station area 45, the report unit 33 may cause the display unit 61 of the report destination terminal 60 to display a graphical user interface (GUI) screen in which the position of the portable base station area 45 is superimposed on the map. An example of the GUI screen is illustrated in FIG. 6. In the example of FIG. 6, the position of the portable base station area 45 where the threat has occurred is highlighted on the map by a circle including the position.

Further, it is considered that there is a suspicious person who has committed an act related to the threat in the vicinity of the equipment in which the threat has occurred in the portable base station area 45. Therefore, the report unit 33 may generate a warning sound in the vicinity of the equipment, track the vicinity of the equipment with a monitoring camera, or the like.

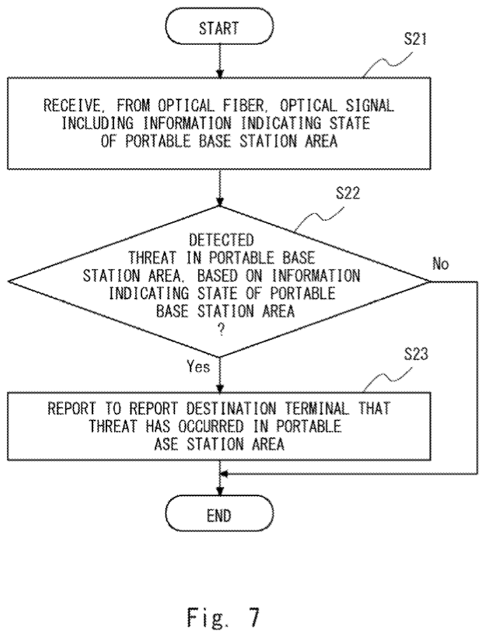

Next, with reference to FIG. 7, an example of the operation flow of the detection system according to the second example embodiment will be described.

As illustrated in FIG. 7, the transmission/reception unit 20 receives an optical signal including information indicating the state of the portable base station area 45 from the optical fiber 10 (step S21).

Then, the acquisition unit 31 acquires information indicating the state of the portable base station area 45 included in the optical signal received by the transmission/reception unit 20, and the detection unit 32 detects a threat (for example, the above-described acts (1) to (3)) in the portable base station area 45, based on the information indicating the state of the portable base station area 45 (step S22).

In step S22, when the detection unit 32 determines that a threat has occurred in the portable base station area 45 (Yes in step S22), subsequently the report unit 33 reports to the report destination terminal 60 of the occurrence of the threat in the portable base station area 45 by telephone, mail, or the like (step S23). At this time, the report unit 33 may cause the display unit 61 of the report destination terminal 60 to display a GUI screen in which the position of the portable base station area 45 is superimposed on a map.

As described above, according to the second example embodiment, when the detection unit 32 determines that a threat has occurred in the portable base station area 45, the report unit 33 reports to the report destination terminal 60 that the threat has occurred in the portable base station area 45. As a result, it is possible to notify a report destination such as a fire department, a police department, or the like that the threat has occurred in the portable base station area 45.

In addition, the report unit 33 may cause the display unit 61 of the report destination terminal 60 to display a GUI screen in which the position of the portable base station area 45 is superimposed on a map. As a result, the position of the portable base station area 45 in which the threat has occurred may also be notified to the report destination such as a fire department, a police department, or the like.

Other effects are similar to those of the first example embodiment described above.

### Modification Example of Second Example Embodiment

This modification example is an example assuming that a plurality of portable base station areas 45 are present in the second example embodiment described above.

When a plurality of portable base station areas 45 are present, a plurality of detection devices 30 are provided in relation to each of the plurality of portable base station areas 45. Each of the plurality of detection devices 30 detects a threat within the related portable base station area 45.

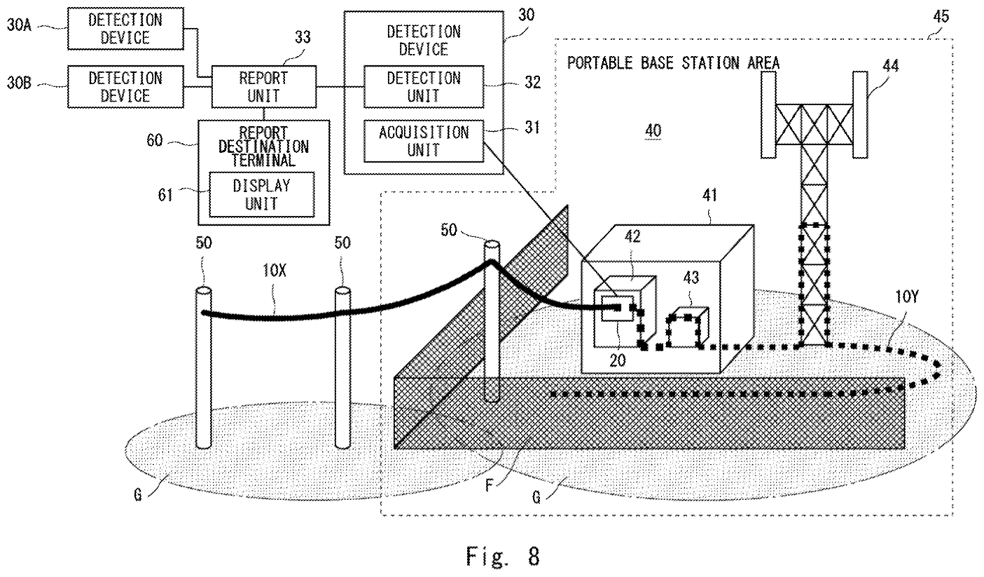

In the example of FIG. 8, in addition to the detection device 30 related to the portable base station area 45, detection devices 30A and 30B relating to each of the portable base station areas 45A and 45B (not illustrated) are provided. That is, in the example of FIG. 8, three detection devices 30, 30A, and 30B are provided.

In the example of FIG. 8, one report unit 33 is provided for the three detection devices 30, 30A, and 30B.

When any of the detection devices 30, 30A, and 30B determines that a threat has occurred in any of the portable base station areas 45, 45A, and 45B, the report unit 33 reports to the report destination terminal 60 that a threat has occurred inside any of the portable base station areas 45, 45A, and 45B.

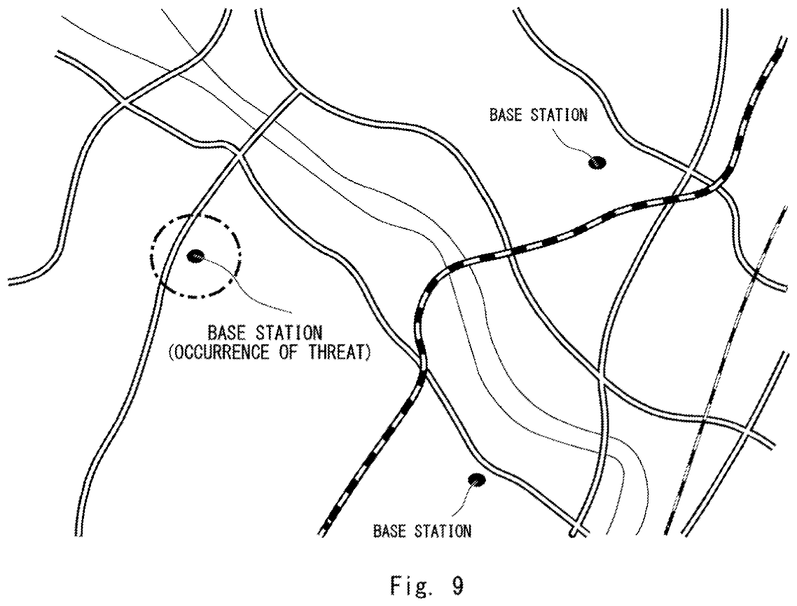

The report unit 33 may hold in advance information indicating the positions of the portable base station areas 45, 45A, and 45B and map information in association with each other. Then, when any of the detection devices 30, 30A, and 30B determines that a threat has occurred inside any of the portable base station areas 45, 45A, and 45B, the report unit 33 may cause the display unit 61 of the report destination terminal 60 to display a GUI screen in which the position of the portable base station area in which the threat has occurred among the portable base station areas 45, 45A, and 45B is superimposed on the map. An example of this GUI screen is illustrated in FIG. 9. In the example of FIG. 9, the position of each of the three portable base station areas 45, 45A, and 45B is represented on the map, and the position of the portable base station area in which the threat has occurred is highlighted by a circle including the position.

### Other Example Embodiments

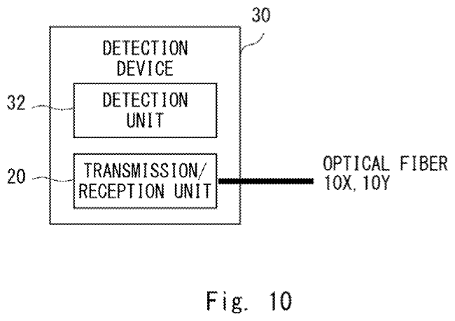

In the example embodiments described above, the transmission/reception unit 20 and the detection device 30 are separated from each other, but the present invention is not limited thereto. The transmission/reception unit 20 and the detection device 30 may be integrated, and the transmission/reception unit 20 may be provided inside the detection device 30. FIG. 10 illustrates a configuration example of a detection device 30 in which a transmission/reception unit 20 is provided. In the example of FIG. 10, since the transmission/reception unit 20 and a detection unit 32 are provided inside the same detection device 30, an acquisition unit 31 is removed. In the detection system illustrated in FIGS. 1, 2, 5, and 8, the detection device 30 illustrated in FIG. 10 may be provided inside the wireless device 42 instead of the transmission/reception unit 20.

Further, in the example embodiments described above, the detection unit 32 detects the above-described acts (1) to (3) as the threat in the portable base station area 45, but the present invention is not limited thereto. For example, the detection unit 32 may detect an intrusion into the portable base station area 45, a suspicious act in the portable base station area 45, a theft of the optical fibers 10X, 10Y, or the like.

Among the above acts, with respect to the intrusion and the suspicious act in the portable base station area 45, for example, in the method A described above, the detection unit 32 may add vibration patterns when the intrusion and the suspicious act occur as the matching pattern. Alternatively, in the method B described above, the detection unit 32 may cause the learning model to additionally learn the vibration patterns when the intrusion or the suspicious act occurs.

Further, with respect to the theft of the optical fibers 10X,10Y, for example, the detection unit 32 may determine that the optical fiber 10X has been stolen based on the fact that an optical signal from the optical fiber 10X has been cut off, the fact that an optical signal having a large vibration intensity has been detected in the optical fiber 10X, and the like. In addition, the detection unit 32 may similarly determine the case where the optical fiber 10Y is stolen.

Further, in the example embodiments described above, one transmission/reception unit 20 and one detection device 30 are provided for each of the plurality of optical fibers 10X, 10Y, but the present invention is not limited thereto. For example, a plurality of transmission/reception units 20 and a plurality of detection devices 30 may be provided for each of the plurality of optical fibers 10X, 10Y, respectively.

### Hardware Configuration of Detection Device According to the Example Embodiments

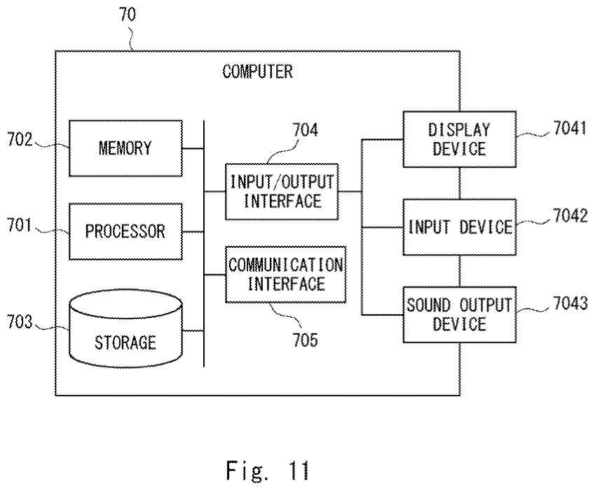

Next, with reference to FIG. 11, a hardware configuration of a computer 70 that implements the detection device 30 according to the example embodiments described above will be described.

As illustrated in FIG. 11, the computer 70 includes a processor 701, a memory 702, a storage 703, an input/output interface (input/output I/F) 704, a communication interface (communication I/F) 705, and the like. The processor 701, the memory 702, the storage 703, the input/output interface 704, and the communication interface 705 are connected to each other through a data transmission path for transmitting and receiving data between each other.

The processor 701 is, for example, an arithmetic processing unit such as a central processing unit (CPU) or a graphics processing unit (GPU). The memory 702 is, for example, a memory such as a random-access memory (RAM) or a read-only memory (ROM). The storage 703 is, for example, a storage device such as a hard disk drive (HDD), a solid-state drive (SSD), or a memory card. The storage 703 may also be a memory such as a RAM or a ROM.

The storage 703 stores programs for implementing functions of the constituent elements included in the detection device 30. The processor 701 executes the programs to implement each of the functions of the constituent elements included in the detection device 30. Herein, when executing the programs, the processor 701 may read the programs onto the memory 702 and then execute the programs, or may execute the programs without reading the programs onto the memory 702. In addition, the memory 702 and the storage 703 also serve to store information and data held by the constituent components included in the detection device 30.

Further, the programs described above may be stored using various types of non-transitory computer readable media and provided to a computer (including the computer 70). Non-transitory computer readable media include various types of tangible storage media. Examples of non-transitory computer readable media include magnetic recording medium (e.g., a flexible disk, a magnetic tape, or a hard disk drive), magneto-optical recording medium (e.g., a magneto-optical disk), a compact disc-ROM (CD-ROM), a CD-recordable (CD-R), a CD-rewritable (CD-R/W), a semiconductor memory (e.g., a mask ROM, a programmable ROM (PROM), an erasable PROM (EPROM), a flash ROM, or a RAM. The program may also be supplied to the computer by various types of transitory computer readable media. Examples of transitory computer-readable media include electrical signals, optical signals, and electromagnetic waves. The transitory computer readable medium may provide the program to the computer via a wired communication path, such as an electrical wire or an optical fiber, or via a wireless communication path.

The input/output interface 704 is connected to a display device 7041, an input device 7042, a sound output device 7043, and the like. The display device 7041 is a device for displaying a screen corresponding to drawing data processed by the processor 701, such as a liquid crystal display (LCD), a cathode ray tube (CRT) display, or a monitor. The input device 7042 is a device for accepting an operation input by an operator, and is, for example, a keyboard, a mouse, a touch sensor, or the like. The display device 7041 and the input device 7042 may be integrated and provided as a touch panel. The sound output device 7043 is a device, such as a speaker, for acoustically outputting a sound corresponding to the sound data processed by the processor 701.

The communication interface 705 transmits and receives data to and from an external device. For example, the communication interface 705 communicates with an external device via a wired communication path or a wireless communication path.

While the present disclosure has been particularly shown and described with reference to the example embodiments described above, the present disclosure is not limited to the example embodiments. It will be understood by those of ordinary skill in the art that various changes in form and details may be made therein without departing from the spirit and scope of the present disclosure as defined by the claims.

For example, some or all of the example embodiments described above may be used in combination with each other.

In addition, the whole or part of the example embodiments disclosed above can be described as, but not limited to, the following supplementary notes.

### Supplementary Note 1

A detection system comprising:

an optical fiber configured to be laid in a portable base station area in which a portable base station is installed;

a reception unit configured to receive an optical signal from the optical fiber, the optical signal including information indicating a state of the portable base station area; and

a detection unit configured to detect a threat in the portable base station area, based on the information indicating a state of the portable base station area being included in the optical signal.

### Supplementary Note 2

The detection system according to Supplementary Note 1, wherein the detection unit detects destruction of equipment of the portable base station as a threat within the portable base station area.

### Supplementary Note 3

The detection system according Supplementary Note 1, wherein the detection unit detects theft of equipment of the portable base station as a threat within the portable base station area.

### Supplementary Note 4

The detection system according to any one of Supplementary Notes 1 to 3, further comprising:

a report destination terminal; and

a report unit configured to report to the report destination terminal, when the detection unit determines that a threat has occurred in the portable base station area, that the threat has occurred in the portable base station area.

### Supplementary Note 5

The detection system according to Supplementary Note 4, wherein the report destination terminal includes a display unit, and the report unit superimposes, when the detection unit determines that a threat has occurred in the portable base station area, on a map, a position of the portable base station area in which the threat has occurred, and causes the display unit to display the position.

### Supplementary Note 6

A detection device comprising:

an acquisition unit configured to acquire information indicating a state of a portable base station area in which a portable base station is installed, the information being included in an optical signal received from an optical fiber laid in the portable base station area; and

a detection unit configured to detect a threat in the portable base station area, based on the information indicating a state of the portable base station area.

### Supplementary Note 7

The detection device according to Supplementary Note 6, wherein the detection unit detects destruction of equipment of the portable base station as a threat within the portable base station area.

### Supplementary Note 8

The detection device according to Supplementary Note 6, wherein the detection unit detects theft of equipment of the portable base station as a threat within the portable base station area.

### Supplementary Note 9

The detection device according to any one of Supplementary Notes 6 to 8, further comprising a report unit configured to, when the detection unit determines that a threat has occurred in the portable base station area, report to a report destination terminal that the threat has occurred in the portable base station area.

### Supplementary Note 10

The detection device according to Supplementary Note 9, wherein, when the detection unit determines that a threat has occurred in the portable base station area, the report unit superimposes, on a map, a position of the portable base station area in which the threat has occurred and causes a display unit of the report destination terminal to display the position.

### Supplementary Note 11

A detection method by a detection system, comprising:

a receiving step of receiving an optical signal from an optical fiber laid in a portable base station area in which a portable base station is installed, the optical signal including information indicating a state of the portable base station area; and

a detecting step of detecting a threat in the portable base station area, based on the information indicating a state of the portable base station area being included in the optical signal.

### Supplementary Note 12

The detection method according to Supplementary Note 11, wherein the detecting step includes detecting destruction of equipment of the portable base station as a threat within the portable base station area.

### Supplementary Note 13

The detection method according to Supplementary Note 11, wherein the detecting step includes detecting theft of equipment of the portable base station as a threat within the portable base station area.

### Supplementary Note 14

The detection method according to any one of Supplementary Notes 11 to 13, further comprising a reporting step of, when determining, in the detecting step, that a threat has occurred in the portable base station area, reporting to a report destination terminal that the threat has occurred in the portable base station area.

### Supplementary Note 15

The detection method according to Supplementary Note 14, wherein the reporting step includes, when determining, in the detecting step, that a threat has occurred in the portable base station area, superimposing a position of the portable base station area in which the threat has occurred, on a map, and displaying the position on a display unit of the report destination terminal.

### REFERENCE SIGNS LIST

### 10X, 10Y OPTICAL FIBER

### 20 TRANSMISSION/RECEPTION UNIT

### 30, 30A, 30B DETECTION DEVICE

### 31 ACQUISITION UNIT

### 32 DETECTION UNIT

### 33 REPORT UNIT

### 40 PORTABLE BASE STATION

### 41 STATION

### 42 WIRELESS DEVICE

### 43 POWER SUPPLY EQUIPMENT

### 44 ANTENNA TOWER

### 45 PORTABLE BASE STATION AREA

### 50 UTILITY POLE

### 60 REPORT DESTINATION TERMINAL

### 61 DISPLAY UNIT

### 70 COMPUTER

### 701 PROCESSOR

### 702 MEMORY

### 703 STORAGE

### 704 INPUT/OUTPUT INTERFACE

### 7041 DISPLAY DEVICE

### 7042 INPUT DEVICE

### 7043 SOUND OUTPUT DEVICE

### 705 COMMUNICATION INTERFACE

### F FENCE

### G UNDERGROUND

What is claimed is:

1. A detection system comprising:
an optical fiber configured to be laid in a portable base station area in which a portable base station is installed;
a reception unit configured to receive an optical signal from the optical fiber, the optical signal including information indicating a state of the portable base station area; and
a detection unit configured to detect a threat in the portable base station area, based on the information indicating a state of the portable base station area being included in the optical signal.

2. The detection system according to claim 1, wherein the detection unit detects destruction of equipment of the portable base station as a threat within the portable base station area.

3. The detection system according claim 1, wherein the detection unit detects theft of equipment of the portable base station as a threat within the portable base station area.

4. The detection system according to claim 1, further comprising:
a report destination terminal; and
a report unit configured to report to the report destination terminal, when the detection unit determines that a threat has occurred in the portable base station area, that the threat has occurred in the portable base station area.

5. The detection system according to claim 4, wherein
the report destination terminal includes a display unit, and
the report unit superimposes, when the detection unit determines that a threat has occurred in the portable base station area, on a map, a position of the portable base station area in which the threat has occurred, and causes the display unit to display the position.

6. A detection device comprising:
an acquisition unit configured to acquire information indicating a state of a portable base station area in which a portable base station is installed, the information being included in an optical signal received from an optical fiber laid in the portable base station area; and
a detection unit configured to detect a threat in the portable base station area, based on the information indicating a state of the portable base station area.

7. The detection device according to claim 6, wherein the detection unit detects destruction of equipment of the portable base station as a threat within the portable base station area.

8. The detection device according to claim 6, wherein the detection unit detects theft of equipment of the portable base station as a threat within the portable base station area.

9. The detection device according to claim 6, further comprising a report unit configured to, when the detection unit determines that a threat has occurred in the portable base station area, report to a report destination terminal that the threat has occurred in the portable base station area.

10. The detection device according to claim 9, wherein, when the detection unit determines that a threat has occurred in the portable base station area, the report unit superimposes, on a map, a position of the portable base station area in which the threat has occurred and causes a display unit of the report destination terminal to display the position.

11. A detection method by a detection system, comprising:
a receiving step of receiving an optical signal from an optical fiber laid in a portable base station area in which a portable base station is installed, the optical signal including information indicating a state of the portable base station area; and
a detecting step of detecting a threat in the portable base station area, based on the information indicating a state of the portable base station area being included in the optical signal.

12. The detection method according to claim 11, wherein the detecting step includes detecting destruction of equipment of the portable base station as a threat within the portable base station area.

13. The detection method according to claim 11, wherein the detecting step includes detecting theft of equipment of the portable base station as a threat within the portable base station area.

14. The detection method according to claim 11, further comprising a reporting step of, when determining, in the detecting step, that a threat has occurred in the portable base station area, reporting to a report destination terminal that the threat has occurred in the portable base station area.

15. The detection method according to claim 14, wherein the reporting step includes, when determining, in the detecting step, that a threat has occurred in the portable base station area, superimposing a position of the portable base station area in which the threat has occurred, on a map, and displaying the position on a display unit of the report destination terminal.
